(19) United States
(12) Patent Application Publication
(10) Pub. No.: US 2008/0154719 A1
(43) Pub. Date: Jun. 26, 2008

(54) MARKET SHARING INCENTIVES

(75) Inventors: Alexander G. Gounares, Kirkland, WA (US); David M. Chickering, Bellevue, WA (US); Michael Connolly, Seattle, WA (US); Lili Cheng, Bellevue, WA (US); Gary W. Flake, Bellevue, WA (US); Eric J. Horvitz, Kirkland, WA (US); Jeffrey R. Hemmen, Renton, WA (US); Leonard Smith, Seattle, WA (US); Tarek Najm, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/769,439

(22) Filed: Jun. 27, 2007

Related U.S. Application Data
(60) Provisional application No. 60/870,926, filed on Dec. 20, 2006.

(51) Int. Cl. G06Q 30/00; G06Q 10/00; G06Q 40/00

(52) U.S. Cl. 705/14; 705/1; 705/39

(57) ABSTRACT

The claimed subject matter relates to an architecture that can quantify a value of a consumer transaction to a market ecosystem. The value to the ecosystem of the transaction can be based upon features of the transaction as well as dynamics unique to the ecosystem. In addition, the value can be monetized as well as aggregated in order to produce a net economic value of a set of transactions involving a particular consumer. The architecture can further facilitate a repatriation of all or portions of the net economic value to the consumer, potentially based upon ranking and/or loyalty tiers.

### CROSS-REFERENCE TO RELATED APPLICATIONS

This application claims the benefit of U.S. Provisional Application Ser. No. 60/870,926, filed Dec. 20, 2006, entitled “ARCHITECTURES FOR SEARCH AND ADVERTISING.” The entirety of this application is incorporated herein by reference.

### BACKGROUND

Conventionally, advertising spending accounts for a substantial expense for many businesses. These and other expenses typically result in higher costs for a product or service, and, thus, a higher purchase price for the end consumer. In the United States alone advertising expenditures constitute about $150 billion annually, ultimately paid for by end consumers. The sheer size of advertising spending is a testament to its effectiveness at persuading a consumer to buy a product or to choose one product over another. However, the benefit of advertising to the end consumer (the ultimate financier of such) is dubious at best, given that an advertising budget might well have been directed instead toward R&D, safety measures, or some other outlet to improve the quality or merit of the actual product or service.

Apart from high cost advertising expenses, more organic forms of advertising exist as well, such as word-of-mouth advertising, consumer testimonials, and the like. When a consumer of a product becomes an advertiser for the product, the results can be very effective. In particular, each consumer has his or her own social network, and, moreover, there is a notion that the quality or merits of the product itself earned the consumer's favor rather than the quality of an advertisement for the product. Additionally, when the consumer becomes the advertiser, an associated cost for advertising can be greatly reduced given that the advertising is not provided by a professional third party but, rather, by the consumer.

Unfortunately there is currently no good way of facilitating a self-sustaining, self-advertising ecosystem that encourages consumers to become advertisers.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises an architecture for determining or inferring a value of a consumer transaction to a market ecosystem. To these and other related ends, the architecture can define ecosystems in a variety of ways for a set of products/services. According to an aspect of the claimed subject matter, the architecture can monitor consumer transactions that affect the ecosystem such as transactions relating to purchases, ratings, reviews, product recommendations, reviewer recommendations, agreements to share (personally or anonymously) relevant information, and so forth. The architecture can also facilitate obtaining relevant data relating to the transactions such as data to uniquely identify a consumer involved in a transaction, a time, type, or price associated with the transaction, as well as transaction histories or appropriate demographics associated with the consumer.

Based potentially upon information collected, the architecture can quantify and/or monetize an economic value of each of the transactions. The economic value can be based upon relationships with other transactions as well as be weighted to cater to particular dynamics of the ecosystem. For example, if the ecosystem maintains an abundance of a first type of a transaction but a shortage of a second type of transaction, then the second type can be favorably weighted in the determination of economic value.

According to one aspect of the claimed subject matter, the economic value associated with a transaction can be aggregated with respect to a particular consumer. Hence, the aggregate economic value can reflect a single consumer's contribution to the ecosystem based upon the sum of all transactions in which the consumer was in some way involved. For example, when viewed in a suitable context, many consumer behaviors can be characterized as a testimonial or an advertisement for a product. While ranking a product very highly can indicate a high level of satisfaction or support for the product, merely purchasing a product can be a form of testimonial as well.

In another aspect, the architecture can facilitate a repatriation of the economic value (either per transaction or in the aggregate) back to the consumer in the form of a market share. The share can be repatriated as a monetary award or as a discount or subsidy. In addition, the architecture can facilitate a ranking for the consumer with respect to other consumers based upon respective behavior and/or transactions. Hence, consumers can be ranked based upon the respective contribution to the ecosystem.

Additionally, the architecture can facilitate the creation of loyalty tiers that define various thresholds for which consumers can qualify based upon respective behavior and/or transactions. The loyalty tiers can be populated based upon consumer ranking, based up the thresholds, or combinations of the two. Moreover, the share can be repatriated based upon the loyalty tier associated with a consumer.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 is a block diagram of a computer-implemented system that can determine a value of a consumer transaction to a market ecosystem.

FIG. 2 illustrates a block diagram of a number of examples of consumer transaction.

FIG. 3 depicts a block diagram of a variety of examples of information obtained.

FIG. 4 illustrates a block diagram of a system that can repatriate portions of the economic value associated with one or more transactions back to the contributing consumer.

FIG. 5 is a block diagram of a system that can examine transactions relating to the ecosystem with respect to a particular consumer in order to rank the consumer.

FIG. 6 illustrates an exemplary flow chart of procedures that define a computer implemented method for determining a value of a consumer transaction for a market ecosystem.

FIG. 7 is an exemplary flow chart of procedures for a computer implemented method for defining ecosystems and repatriating value.

FIG. 8 depicts an exemplary flow chart of procedures defining a computer implemented method for aggregating values with respect to a consumer and/or ranking the consumer based upon the aggregate value.

FIG. 9 illustrates a block diagram of a computer operable to execute the disclosed architecture.

FIG. 10 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, or the like can refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

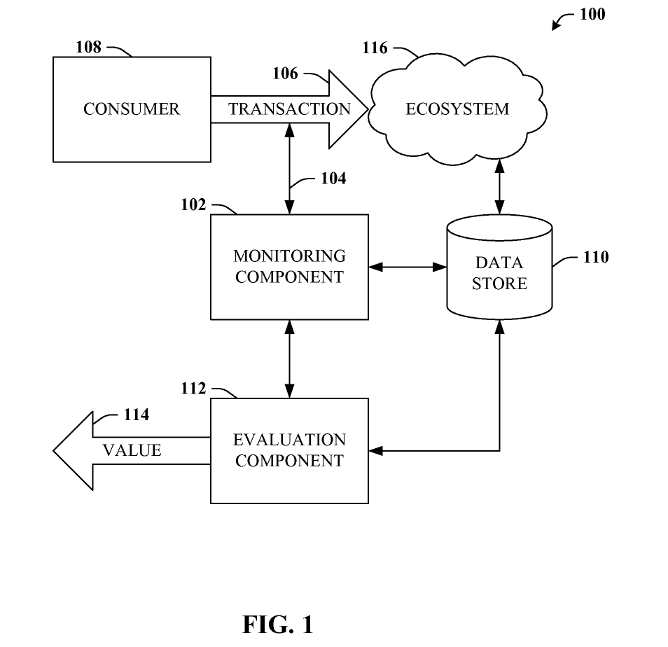

Referring now to the drawing, with reference initially to FIG. 1, a computer-implemented system 100 that can determine a value of a consumer transaction to a market ecosystem is depicted. Generally, the system 100 can include a monitoring component 102 that can obtain information 104 associated with a consumer transaction 106, wherein the consumer transaction 106 involves a consumer 108 and affects a market ecosystem 116. The market ecosystem 116 can be an ecosystem that can facilitate and/or encourage the consumer 108 to become an advertiser as well as to facilitate or encourage the consumer 108 to contribute to the ecosystem 116. Such can be accomplished by way of incentives, which is further detailed infra. In addition, the monitoring component 102 can store the information 104 to a data store 110.

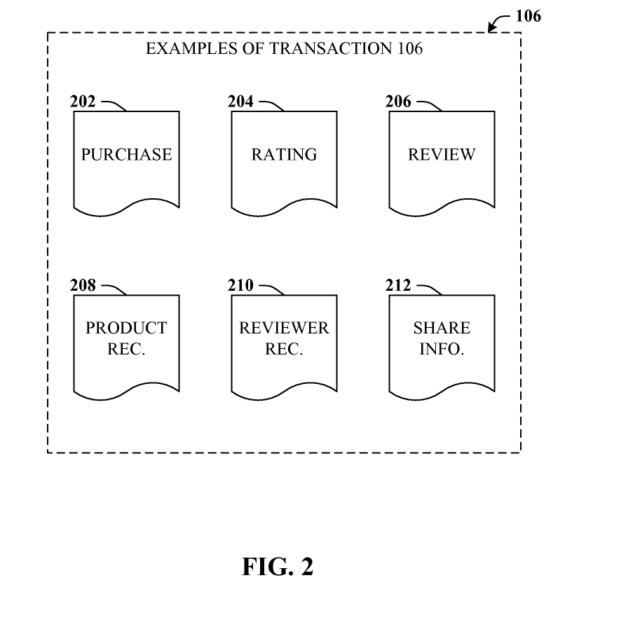

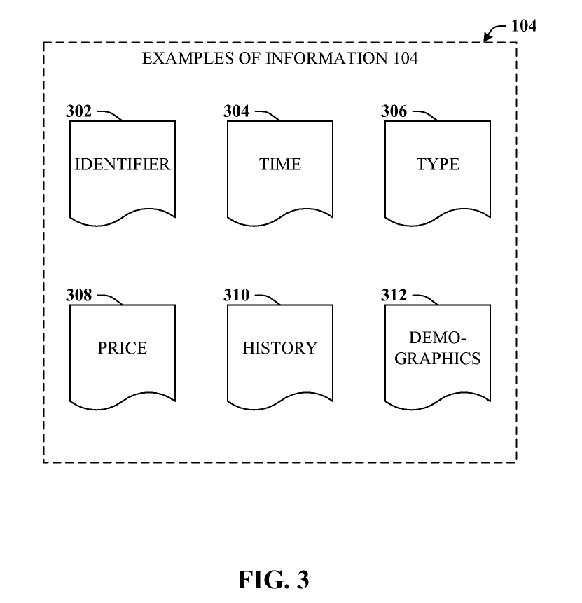

The consumer transaction 106 typically affects the market ecosystem 116 when the consumer transaction 106 relates either directly or indirectly to a product (e.g., a good or a service) for which the market ecosystem 116 is defined to include, which is described in more detail infra. In accordance therewith, the consumer transaction 106 can consist of a wide variety of actions or behaviors, which are further described in connection with FIG. 2. Likewise, the information 104 associated with the consumer transaction 106 can relate to numerous aspects of the consumer transaction 106, and is discussed in greater detail with reference to FIG. 3. In order to provide a better understanding of the claimed subject matter, FIGS. 2 and 3 will now be addressed before continuing the discussion of FIG. 1.

FIG. 2 illustrates a number of examples of consumer transaction 106. It is to be appreciated that the following examples are intended to provide concrete illustrations but are not necessarily intended to limit the claimed subject matter to only the examples provided. Rather, other types of transaction 106 can exist and can be applicable to the appended claims. One common example of consumer transaction 106 can be a purchase 202 of a product included in the ecosystem 116, such as when the consumer 108 purchases the product. However, a consumer transaction 106 can also be a non-purchase transaction or non-purchase-specific aspects of a purchase transaction 202, including, but not limited to, the examples provided by reference numerals 204-212. For instance, the transaction 106 can relate not only to the purchase 202, but to an indication (e.g., to a disparate consumer 108) that the product was purchased by the consumer 108 as well as, e.g., whether the consumer 108 is a new customer or a repeat customer. Another type of consumer transaction 106 can be a rating 204 associated with the product included in the ecosystem 116, such as when the consumer 108 rates one or more features of the product or when the consumer 108 accesses a rating 204 provided by a disparate consumer 108.

The consumer transaction 106 can also apply to a review 206 of the product included in the ecosystem 116, such as when the consumer 108 provides or accesses a written review relating to various features of the product. A recommendation 208 for a product included in the ecosystem 116 illustrates another example of consumer transaction 106. It is to be appreciated that the recommendation 208 can relate to one or more products in the ecosystem. For example, the recommendation 208 can accompany a purchase 202, rating 204, and/or review 206 of a first product for which the consumer 108, e.g. believes is inferior to a second product. Thus, the recommendation 208 can be for the second product, yet also relate to the first product.

Another type of consumer transaction 106 can be a reviewer recommendation 210. While recommendation 208 typically relates directly to a product, reviewer recommendation 210 can relate to a reviewer of products included in the ecosystem 116. For instance, consumer 108 may find a review written by another consumer 108 to be very helpful, and therefore, provide a reviewer recommendation 210. The consumer transaction 106 can also be an agreement to share 212 information, including but not limited to information 104.

For example, conventionally, there is a constant struggle between businesses and consumers relating to access to or the sharing of information. Businesses typically want to collect as much information about a consumer as possible in order to, e.g., better serve or more appropriately appeal to the consumer, yet, consumers typically want to keep this information private. Accordingly, a decision to share 212 relevant information can have an impact on the ecosystem 116, and, moreover, the information can be associated with a particular consumer identification/profile, or be provided as a set of anonymous statistics.

Turning now to FIG. 3, a variety of examples of information 104 are provided. Again, it is to be understood that the examples of information 104 described herein are intended provide context for the claimed subject matter, but are not necessarily intended to be limiting. Information 104 can include data such as an identifier 302 associated with the consumer 108 involved in the transaction 106. The identifier 302 can be, e.g. employed to access an account maintained in the data store 110 that relates to substantially any number of consumer transactions 106 that affect a product associated with one or more ecosystems 116.

According to another aspect of the claimed subject matter, a time 304 of the transaction 106 can be included in the information 104. In several applications, recording when the transaction 106 occurred can be of use. Moreover, a type 306 of consumer transaction 106 can also be designated by the information 104. For example, the type 306 can describe one or several of the various types of consumer transactions 106 detailed in FIG. 2, supra. In addition, a price 308 can be included in the information 104. Typically, the price 308 is associated with a consumer transaction 106 that is a purchase 202, and may not be applicable to some other types of consumer transactions 106.

Another example of information 104 can be a transaction history 310 of the consumer 108. Thus, while the monitoring component 102 can obtain information 104 relevant to a current transaction 106, similar information 104 can be obtained relating to one or more previous transactions 106 from, e.g. the data store 110 or another suitable source such as a device associated with the consumer 108. The information 104 can further include a demographic 312 of the consumer 108. The demographic 312 can be, e.g., an indication of age, gender, income, hobbies/interests, relationships, location, and so on; and the demographic 312 can be expressly indicated by way of the transaction 106 or inferred based upon the transaction 106, potentially employing additional data sets that can also be included in the data store 110.

With the foregoing in mind, FIG. 1 can now be referenced again to continue with the discussion. As detail supra, the monitoring component 102 can obtain information 104 associated with a consumer transaction 106. In addition, the system 100 can also include an evaluation component 112 that can determine an economic value 114 of the transaction 106 with respect to the ecosystem 116. For example, as the transaction 106, irrespective of the type of the transaction 106, will likely affect the ecosystem 116 in a quantifiable way, the actual quantifiable effect can be monetized as the economic value 114.

As one straightforward example, suppose the consumer 108 purchases a product relating to the ecosystem 116. The purchase 202 likely provided proceeds and/or profits to a third party in exchange for some utility to the consumer 108, which, in turn can have a net effect on the ecosystem 116. Hence, the value 114 to the ecosystem can be an aggregate measure of benefits associated with the third party, the consumer 108 as well as other parties effected by or that affect the ecosystem 116 with respect to the purchase 202. It is to be appreciated that the value 114 to the ecosystem 116 can be distinct from a value associated with profits from the purchase 202, although both can be defined in terms of a quantifiable economic effect. For example, conventionally, it can be very simple to quantify the effects of profits to one's bottom line, however, the effects to the ecosystem 116 itself, even for an identical purchase 202, can be markedly different from the effects to the bottom line, which is merely one means of quantifying the purchase in economic terms. For instance, the purchase 202 can have a distinct value 114 to the ecosystem 116 depending upon whether the consumer 108 is a repeat customer or a new customer, even though the observed profits may be identical, and therefore impossible to granularly distinguish based upon convention balance sheet metrics. Thus, numerous effects associated with the purchase 202 can be quantified and/or monetized not only as it applies to the parties involved in the transaction 106, but to the ecosystem 116 as a whole.

As a slightly more involved example, consider the following three consumer transactions 106. A first transaction 106 is a rating 204 of a product by a first consumer 108. A second transaction 106 occurs when a second consumer 108 accesses the rating 204 provided by the first consumer 108, and a third transaction 106 is brought about when the second consumer 108 purchases the product that was rated by the first consumer 108. In each case, the economic value 114 of the respective transaction 106 to the ecosystem 116 can be determined or inferred. In particular, the economic value 114 of the rating 204 by the first consumer 108, the reference to the rating 204 by the second consumer 108, and the associated purchase of the product by the second consumer 108 can be quantified or monetized based potentially upon weights assigned to all or portions of the related transactions 106 as well as any other suitable data available in the data store 110.

It is to be appreciated that the economic value 114 can be determined or inferred based upon a wide variety of available data as well as based upon machine learning techniques known or described herein. In addition, the determination or inference can be substantially affected by various existing or perceived relationships between individual consumer transactions 106 as well as numerous other data or data sets. For example, in order to determine or infer the economic value 114, the evaluation component 112 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

It is to be appreciated that the economic value 114 can pertain to a contribution to the ecosystem 116 or pertain to an acquisition cost for securing a desired transaction 106. For example, if the ecosystem 116 has a very large number of purchases 202, but very few product reviews 206 or consumers 108 who have elected to share 212 information, then the economic value 114 for a purchase 202 may be lower than for a review 206 or an agreement to share 212 information. Moreover, the economic value 114 for a given transaction 106 can be unique for a particular ecosystem 116 as well as evolve over time within a given ecosystem 116.

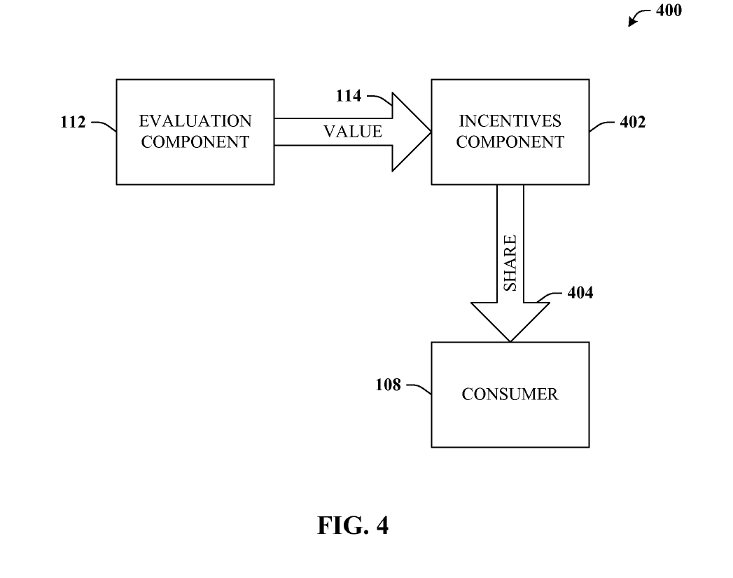

For example, as will be detailed further in connection with FIG. 4, incentives can be provided to consumer 108 as a result of certain behavior and/or certain transactions 106 in accordance with the economic value 114 those behaviors or transactions 106 had on the ecosystem 116. Thus, it is to be understood that such incentives can also affect the ecosystem 116 over time. For instance, assigning a relatively high economic value 114 to a particular type of transaction 106 (e.g. a transaction desired and/or favored by the ecosystem 116) can result in many additional transaction 106 of that type. Over time, transactions 106 of that type may diminish in significance to the ecosystem 116, which can result in a lower economic value 114 for an identical (e.g., all other factors being substantially equal) transaction 106 provided at a later time. Moreover, such incentives can allow consumers 108 to become effective advertisers for the ecosystem 116, potentially resulting in a substantial cost savings to the ecosystem 116 in terms of advertising expenses, all or portions of which can be reinvested in ecosystem 116 participants rather than allocated to third parties.

In addition, it is also to be appreciated that many distinct ecosystems 116 can be employed. Thus, a first ecosystem 116 can be defined differently than a second ecosystem 116. For example, in one scenario, the ecosystem 116 can be defined in terms of a retailer of competing products, whereas in another scenario (or as a different ecosystem) the ecosystem 116 can be defined in terms of a brand of products. Therefore, a given transaction 106 may affect the first ecosystem 116, but not the second ecosystem 116. Or, in other cases, the economic value 114 of the transaction 106 may diverge based upon the particular ecosystem 116 to which it is applied.

To provide a concrete illustration of the above, consider a first ecosystem 116 defined by the supermarket where the consumer 108 usually shops, and a second ecosystem 116 defined by a manufacturer of a line of breakfast foods the consumer 108 usually purchases. It is readily apparent that a purchase 202 from the supermarket of a breakfast food supplied by the manufacturer can have an effect on both ecosystems 116. However, given that, e.g., margins on the sale of the product, as well as any number of other factors, will differ between a retailer and a manufacturer, an associated economic value 114 to the associated ecosystem 116 can differ as well. Moreover, a purchase 202 of a competing product may provide a substantially similar economic value 114 to the ecosystem 116 of the retailer, yet may in some cases not be defined by ecosystem 116 defined by the manufacturer, since the competing product can be a different brand and/or supplied by a different manufacturer. The reverse situation can apply when, e.g., the consumer 108 purchases the product from a different supermarket.

In the latter case, the transaction 106 for the breakfast food may not be directly relevant to the supermarket, as the purchase 202 was made elsewhere. However, by sharing this information (e.g., sharing 212), the information can suggest an impact on the ecosystem 116 at least insofar as the retailer can infer that particular consumer 108 is not likely to purchase the breakfast food from the supermarket for at least an additional week or other time period suggested by, say, the consumer's 108 historical consumption habits. In particular, being privy to the above shared 212 information can itself be assigned in economic terms a value 114 with respect to a given ecosystem 116.

With reference now to FIG. 4, a system 400 that can repatriate portions of the economic value associated with one or more transactions back to the contributing consumer is illustrated. In general, the system 400 can include the evaluation component 112 that can determine or infer an economic value 114 of the transaction 106 with respect to the ecosystem 116, as substantially described herein. In addition, the system 400 can also include an incentives component 402 that can repatriate a share 404 of the economic value 114 associated with a transaction 106 to the consumer 108 involved in the transaction 106.

For example, consider the case in which a first consumer 108 authors a review of a product, a second consumer 108 recommends the review of the product to others, and a third consumer 108 reads the review and purchases the product. Each of the various transactions 106 included in the foregoing can be discretely valued vis-à-vis one or more ecosystems 116, and each can result in or be a part of an aggregate share 404 provided to the associated consumer 108. It is to be appreciated that the share 404 can be repatriated as a monetary award such as a fractional share 404 of the consumer's 108 contributions to the ecosystem 116. Additionally or alternatively, the share 404 can be repatriated as a discount that is, e.g. redeemable upon a purchase of one or more products.

Accordingly, in one aspect, the consumer 108 can become an advertiser by doing nothing more than engaging in suitable market transactions 106, many of which the consumer 108 might be inclined or motivated to carry out at his or her own behest. In addition, the behavior of the consumer 108 can be a testimonial that can replace or supplement conventional advertising and the expenses associated therewith. For example, information 104 suggesting that shopper X buys a particular product, or that Brand A represents 60% of all sales of a particular of product can be persuasive forms of advertising/testimonials for a retailer or manufacturer. Furthermore, the share 404 can be partially funded by advertising expense reductions, and can therefore efficiently promote additional transactions 106 such as additional purchases 202 or an incentive for consumer 108 to provide a review 206, a rating 204, recommendations 208, 210, and so on. Even a consumer 108 who engages in only one type of transaction 106 can substantially contribute to the ecosystem 116. For instance, a consumer 108 who purchases a lot can be an indication that the consumer's 108 attention is valuable and/or that ratings from other consumers 108 might be useful.

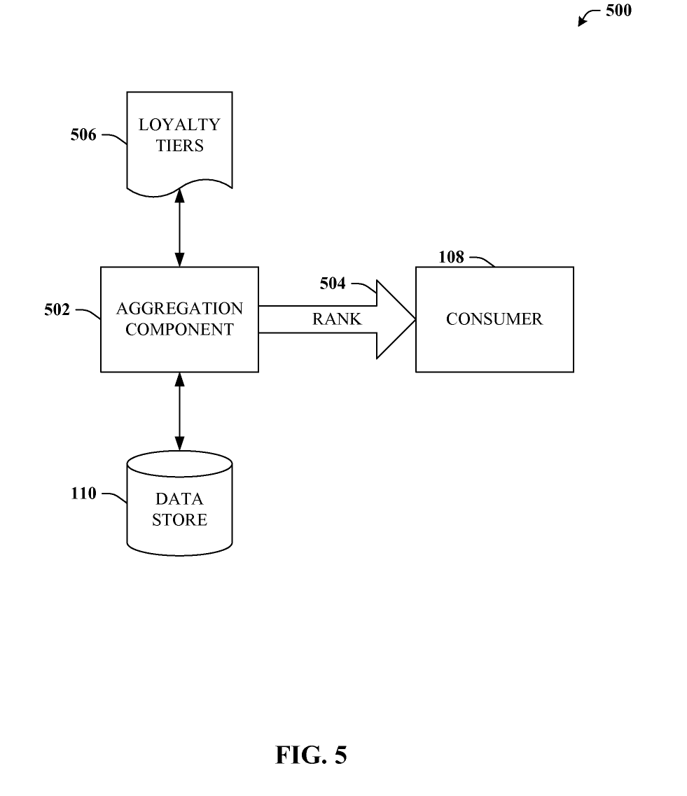

Referring now to FIG. 5, illustrated is a computer-implemented system 500 that can examine transactions relating to the ecosystem with respect to a particular consumer in order to rank the consumer. In accordance therewith, the system 500 can include an aggregation component 502 that can determine a rank 504 of the consumer 108 involved in the transaction 106 with respect to other consumers 108 who affect the ecosystem 116. According to one aspect of the claimed subject matter, the rank 504 can be determined based upon an aggregation of the economic values 114 associated with the consumer 108. For example, economic values 114 for many consumer transactions 106 involving the consumer 108 can be aggregated in order to determine the rank 504 relative to other consumers 108. It is to be appreciated that the aggregation component 502 can determine the rank 504 based upon all or portions of relevant information 104 stored in the data store 110. It is to be further appreciated that the consumer 108 need not be a single individual. Rather, the consumer 108 can be substantially any entity or collection of individuals or entities that can be represented by, e.g., an account or a consumer account.

In accordance with another aspect of the claimed subject matter, the aggregation component 502 can define a set of loyalty tiers 506 (referred to herein either collectively or individually as loyalty tier(s) 506). For example, the loyalty tiers 506 can be defined based upon suitable thresholds of participation and/or contributions to the ecosystem 116, which can generally be satisfied by virtue of transactions 106. The highest loyalty tier 506 can be, e.g., for platinum members/consumers 108, followed by the “gold” tier 506, and so on, yet other denotations or labels are of course possible and applicable to the claims appended hereto.

In accordance with the foregoing, the aggregation component 502 can populate each of the loyalty tiers 506 with consumer 108 based upon the rank 504 of the consumer 108. Thus, consumers 108 with the highest rank 504 can be assigned to the highest tiers 506. Moreover, the share 404 repatriated to the consumer 108 can be in proportion to the tier 506 rather than based solely upon the economic value 114.

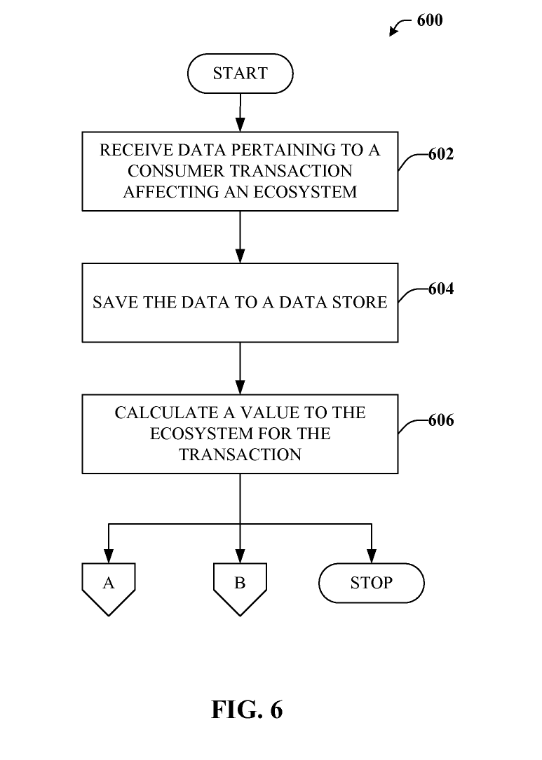

FIGS. 6, 7, and 8 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 6, an exemplary computer-implemented method 600 for determining a value of a consumer transaction for a market ecosystem is illustrated. Generally, at reference numeral 602, data pertaining to a consumer transaction affecting an ecosystem can be received. For example, the consumer transaction can be purchase of a product, providing or accessing a rating or review for a product, providing or accessing a product or a reviewer recommendation for a product, an agreement to share suitable data, and so on. Hence, the data pertaining to the consumer transaction can be, e.g., an identifier associated with the consumer involved in the transaction; a time, a price, or type of transaction; as well as a history of related transaction and/or demographics associated with the consumer.

At reference numeral 604, the data can be saved to a data store. It is to be appreciated that the data store can warehouse not only the above-mentioned data, but can be a repository for many additional data sets that can be useful for determinations and/or inferences associated with a market ecosystem. At reference numeral 606, a value to the ecosystem can be calculated for the transaction. While the transaction itself can range from a purchase of a product to an agreement to share transaction information, each transaction, regardless of its particular type or particular effect, can be monetized with respect to the ecosystem as a whole. Such a monetization of the effect of the transaction on the ecosystem can constitute the calculated value.

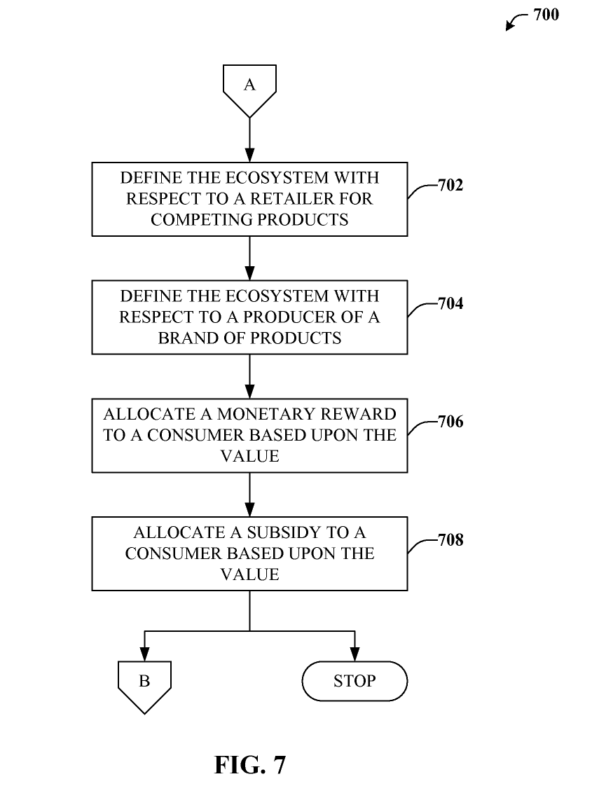

With reference now FIG. 7, an exemplary method 700 for defining ecosystems and repatriating value is provided. At reference numeral 702, the ecosystem can be defined with respect to a retailer for competing products. At reference numeral 704, the ecosystem can be defined with respect to a producer of a brand of products. It is to be appreciated that depending upon the manner in which the ecosystem is defined, various transactions can affect the ecosystem in different ways and/or facilitate a greater or lesser impact. For example, a recommendation for one product over another product that is inferred to be a catalyst for a subsequent purchase can be treated differently by an ecosystem defined by a retailer who sells both products than by an ecosystem defined by a manufacturer of one of the products.

At reference numeral 706, a monetary reward can be allocated to the consumer based upon the value, whereas at reference numeral 708 a subsidy can be allocated to the consumer based upon the value. In particular, acts 706 and 708 can relate to repatriating a portion or share of the value back to the consumer involved in the transaction, wherein the allocation can be in the form of a monetary reward in accordance with act 706 or in the form of a discount or subsidy in accordance with act 708.

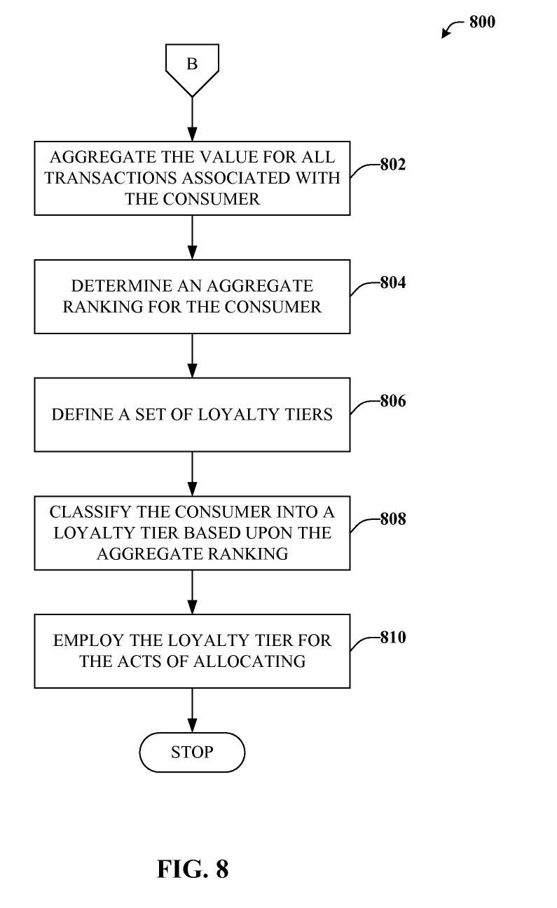

Turning now to FIG. 8, an exemplary method 800 for aggregating values with respect to a consumer and/or ranking the consumer based upon the aggregate value is illustrated. Generally, at reference numeral 802, the value for all transactions associated with the consumer can be aggregated. For example, all the economic values for transactions involving a particular consumer can be collected in the aggregate. At reference numeral 804, an aggregate ranking for the consumer can be determined relative to other consumers whose transactions impact the ecosystem.

At reference numeral 806, a set of loyalty tiers can be defined for the ecosystem in accordance with various thresholds. At reference numeral 808, the consumer can be classified into a loyalty tier from the set of loyalty tiers based upon the aggregated ranking for the consumer determined at act 804. For example, consumers that contribute more to the ecosystem by virtue of transactions that equate to economic value can be ranked above other consumers and can, thus, fall into a higher tier. At reference numeral 810, the loyalty tier can be employed for the acts of allocating described in connection with reference numerals 706 and 708 of FIG. 7.

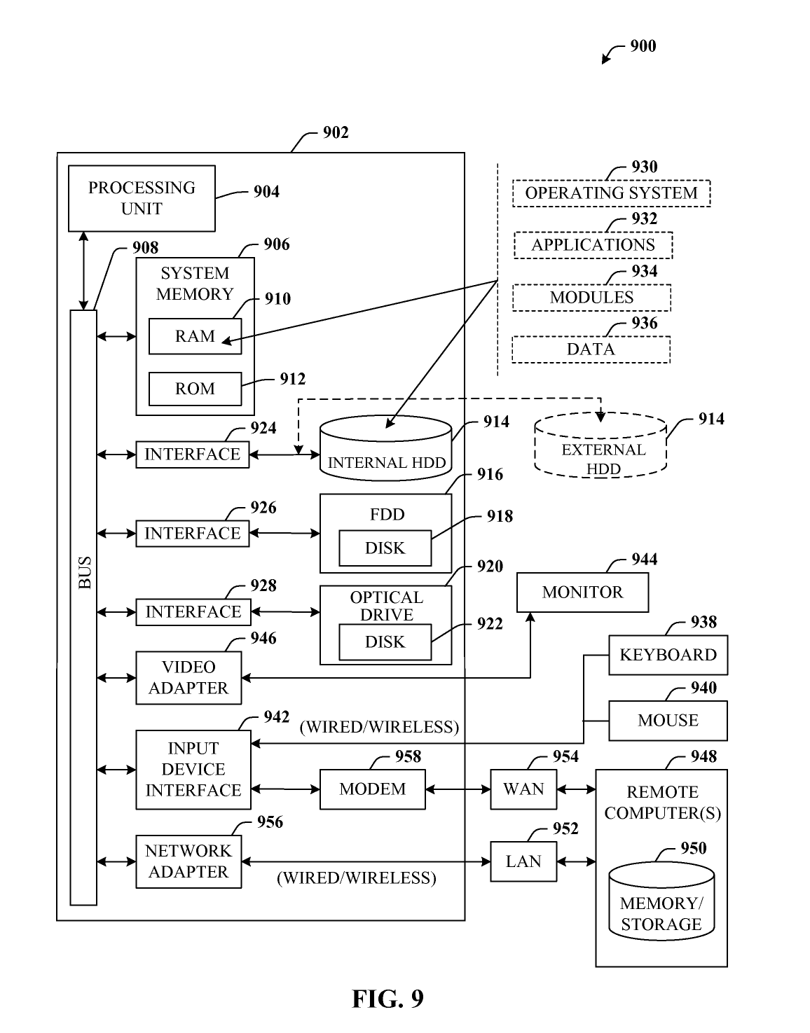

Referring now to FIG. 9, there is illustrated a block diagram of an exemplary computer system operable to execute the disclosed architecture. In order to provide additional context for various aspects of the claimed subject matter, FIG. 9 and the following discussion are intended to provide a brief, general description of a suitable computing environment 900 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the claimed subject matter includes a computer 902, the computer 902 including a processing unit 904, a system memory 906 and a system bus 908. The system bus 908 couples to system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g. reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the claimed subject matter can be implemented with various commercially available operating systems or combinations of operating systems.

A user can enter commands and information into the computer 902 through one or more wired/wireless input devices, e.g. a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g. the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 9BaseT wired Ethernet networks used in many offices.

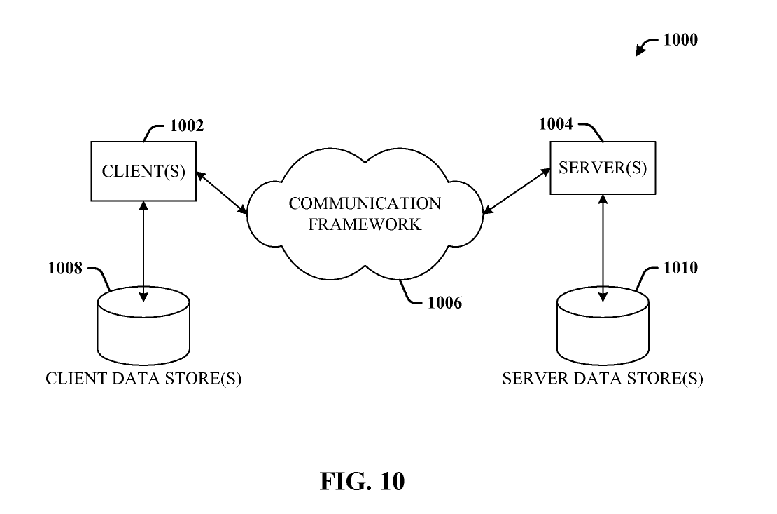

Referring now to FIG. 10, there is illustrated a schematic block diagram of an exemplary computer compilation system operable to execute the disclosed architecture. The system 1000 includes one or more client(s) 1002. The client(s) 1002 can be hardware and/or software (e.g., threads, processes, computing devices). The client(s) 1002 can house cookie(s) and/or associated contextual information by employing the claimed subject matter, for example.

The system 1000 also includes one or more server(s) 1004. The server(s) 1004 can also be hardware and/or software (e.g., threads, processes, computing devices). The servers 1004 can house threads to perform transformations by employing the claimed subject matter, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A computer-implemented system that determines a value of a consumer transaction to a market ecosystem, comprising:
a monitoring component that obtains information associated with a non-purchase consumer transaction that affects a market ecosystem, the monitoring component stores the information to a data store; and
an evaluation component that determines an economic value of the transaction with respect to the market ecosystem based at least in part upon the information in the data store.

2. The system of claim 1, the ecosystem encourages a consumer to promote the ecosystem.

3. The system of claim 1, the transaction is at least one of a purchase of a product included in the ecosystem, a rating associated with the product, a review associated with the product, a recommendation for a second product, a recommendation for a reviewer, or an agreement to share a subset of the information.

4. The system of claim 1, the information includes an identifier associated with a consumer involved in the transaction, a time of the transaction, a type of the transaction, a price associated with the transaction, a purchases history of the consumer, or demographics of the consumer.

5. The system of claim 1, the ecosystem is defined in terms of a retailer of competing products.

6. The system of claim 1, the ecosystem is defined in terms of a brand of products.

7. The system of claim 1, further comprising an incentives component that repatriates a share of the economic value to a consumer involved in the transaction.

8. The system of claim 7, the share is repatriated as a monetary award

9. The system of claim 7, the share is repatriated as a purchase discount.

10. The system of claim 1, further comprising an aggregation component that determines a rank of a consumer involved in the transaction with respect to other consumers who affect the ecosystem.

11. The system of claim 10, the rank is determined based upon an aggregate of the economic value associated with the consumer.

12. The system of claim 10, the aggregation component defines a set of loyalty tiers and populates the loyalty tiers with the consumer based upon the rank.

13. The system of claim 12, a share of the economic value is repatriated to the consumer in proportion to the loyalty tier.

14. A computer-implemented method for determining a value of a consumer transaction for a market ecosystem, comprising:
receiving data pertaining to a consumer transaction affecting an ecosystem;
saving the data to a data store; and
calculating a value to the ecosystem for the transaction based at least in part upon the data.

15. The method of claim 14, further comprising defining the ecosystem with respect to a retailer for competing products.

16. The method of claim 14, further comprising defining the ecosystem with respect to a producer of a brand of products.

17. The method of claim 14, further comprising at least one of the following acts:
allocating a monetary reward to a consumer associated with the transaction based upon the value; or
allocating a subsidy to a consumer associated with the transaction based upon the value.

18. The method of claim 17, further comprising at least one of the following acts:
aggregating the value for all transactions associated with the consumer;
determining an aggregate ranking for the consumer relative to a disparate consumer who impacts the ecosystem;
defining a set of loyalty tiers;
classifying the consumer into a loyalty tier from the set of loyalty tiers based upon the aggregating ranking
employing the loyalty tier for the acts of allocating.

19. A computer-implemented system for evaluation a consumer transaction in terms of a market ecosystem, comprising:
computer-implemented means for obtaining data relating to consumer transactions that affects an ecosystem;
computer-implemented means for storing the data to a data store; and
computer-implemented means for employing the data to determine an economic value contributed to the ecosystem by each of the transaction.

20. The method of claim 19, further comprising at least one of the following:
computer-implemented means for ranking consumers involved in the transactions; or
computer-implemented means for repatriating portions of the economic value contributed to the ecosystem.
